(19) United States
(12) Patent Application Publication
(10) Pub. No.: US 2007/0224467 A1
(43) Pub. Date: Sep. 27, 2007

(54) Deferential Presssure Control Method for Molten Carbonates Fuel Cell Power Plants

(75) Inventors: Gian Paolo Nervi, Cartosio (IT); Filippo Parodi, Recco (IT)

Correspondence Address: STETINA BRUNDA GARRED & BRUCKER, 75 ENTERPRISE, SUITE 250, ALISO VIEJO, CA, 92656, US

(73) Assignee: ANSALDO FUEL CELLS S.P.A., Genova (IT)

(21) Appl. No.: 11/587,416

(22) PCT Filed: May 5, 2004
(86) PCT No.: PCT/EP04/04779

§ 371 Date: Oct. 23, 2006

(51) Int. Cl. H01M 8/14

(52) U.S. Cl. 429/13; 429/25

(57) ABSTRACT

A molten carbonate fuel cell System in which the fuel cell stack(s) is (are) enclosed within a containment vessel and in which a burner exhaust is used to control the system operating pressure is described. Moreover, highly reliable, simple and low-cost differential pressure control method never affected by service interruption or troubles in control valves or other components is disclosed. Excluding differential control valves and reducing the cost by guiding the anode, cathode and vessel exhaust gases to the inlet of a catalytic burner forward the containment vessel and mixed therein so that the pressure of these gases are equal to each other, this fuel cell system guarantees dynamic pressure balancing between the vessel and reactants to prevent leakage of the reactants from the fuel cell stack and avoid an excessive differential pressure between the fuel cell and the vessel and between the anode and the cathode.

At the cathode, oxygen combines with electrons and, in some cases, with species such as protons or water, resulting in water or hydroxide ions, respectively.

For polymer exchange membrane (PEM) and phosphoric acid fuel cells, protons move through the electrolyte to the cathode to combine with oxygen and electrons, producing water and heat.

For alkaline, molten carbonate, and solid oxide fuel cells, negative ions travel through the electrolyte to the anode where they combine with hydrogen to generate water and electrons. The electrons from the anode side of the cell cannot pass through the membrane to the positively charged cathode; they must travel around it via an electrical circuit to reach the other side of the cell. This movement of electrons is an electrical current.

The amount of power produced by a fuel cell depends upon several factors, such as fuel cell type, cell size, the temperature at which it operates, and the pressure at which the gases are supplied to the cell. Still, a single fuel cell produces enough electricity for only the smallest applications. Therefore, individual fuel cells are typically combined in series into a fuel cell stack.

A typical fuel cell stack may consist of hundreds of fuel cells.

Direct hydrogen fuel cells produce pure water as the only emission. This water is typically released as water vapor.

Fuel cell systems can also be fueled with hydrogen-rich fuels, such as methanol, natural gas, gasoline, or gasified coal. In many fuel cell systems, these fuels are passed through “reformers” that extract hydrogen from the fuel. Onboard reforming has several advantages:

First of all it allows the use of fuels with higher energy density than pure hydrogen gas, such as methanol, natural gas, and gasoline. Further, it allows the use of conventional fuels delivered using the existing infrastructure (e.g., liquid gas pumps for vehicles and natural gas lines for stationary source).

High-temperature fuel cell systems can reform fuels within the fuel cell itself—a process called internal reforming—or can use waste heat produced by the fuel cell system to sustain the reforming endothermic reactions (integrated reforming), as disclosed in EP-A-1 321 185.

In addition, impurities in the gaseous fuel can reduce cell efficiency.

The design of fuel cell systems is quite complex and can vary significantly depending upon fuel cell type and application. However, most fuel cell systems consist of four basic components:
A fuel processor
An energy conversion device (the fuel cell or fuel cell stack)
A power converter
Heat recovery system (typically used in high-temperature fuel cell systems used for stationary applications)

Other components and subsystems are foreseen to control fuel cell humidity, temperature, gas pressure, and wastewater.

The first component of a fuel cell system is the fuel processor. The fuel processor converts fuel into a form useable by the fuel cell. If hydrogen is fed to the system, a processor may not be required or it may be reduced to hydrogen storage and feeding systems.

If the system is powered by a hydrogen-rich conventional fuel such as methanol, gasoline, diesel, or gasified coal, a reformer is typically used to convert hydrocarbons into a gas mixture of hydrogen and carbon compounds called “reformate.” In many cases, the reformate is then sent to another reactor to remove impurities, such as carbon oxides or sulfur, before it is sent to the fuel cell stack. This prevents impurities in the gas from binding with the fuel cell catalysts. This binding process is also called “poisoning” since it reduces the efficiency and life expectancy of the fuel cell.

Some fuel cells, such as molten carbonate and solid oxide fuel cells, operate at temperatures high enough that the fuel can be reformed in the fuel cell itself or can use waste heat produced by the fuel cell system to sustain the reforming endothermic reactions.

Both internal and external reforming release carbon dioxide, but less than the amount emitted by internal combustion engines, such as those used in gasoline-powered vehicles, due to high conversion efficiency available with fuel cells.

Fuel cell systems are not primarily used to generate heat. However, since significant amounts of heat are generated by some fuel cell systems—especially those that operate at high temperatures such as solid oxide and molten carbonate systems—this excess energy can be used to supply thermal energy to sustain reforming reactions, to produce steam or hot water or converted to electricity via a gas turbine or other technology. This increases the overall energy efficiency of the systems.

A prior-art device of the type disclosed in the present case is, for example, a fuel cell device as described in the U.S. Pat. No. 4,904,547.

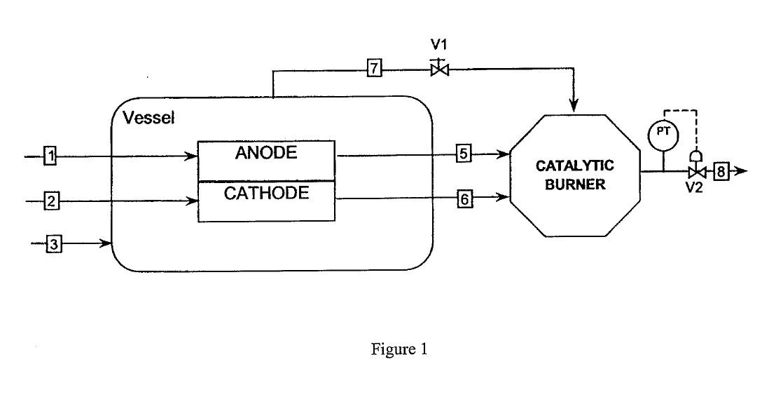

Here, the pressure difference controlling method is schematically illustrated in FIG. 1, where a switching valve 11 connects a nitrogen line and a fuel line and is installed outside a vessel while a switching valve 12 connects the nitrogen line and an air line.

The first pressure controller 13 applies a set signal to a fuel differential pressure control valve 4 upon receiving a signal from the first differential pressure detector which detects the differential pressure between the vessel pressure and the anode exhaust. A second pressure controller 15 applies a set signal to the cathode differential pressure control valve 4 upon receiving a signal from the second differential pressure detector, which detects the differential pressure between the vessel pressure and the cathode exhaust.

During the functioning, the system pressure is regulated by the pressure control valve 8 and the controllers for the differential control pressure vessel-anode and vessel-cathode are the controller 13 and 15 respectively; switching valves 11 and 12 are closed.

In case of a urgent system stop, valve 7, 3, 5 close, while switching valves 11 and 12 open, allowing the natural decrease of the nitrogen pressure in the vessel. Consequently the pressures of the respective lines lower to the normal pressure according to the pressure control system. In this way the fuel cell can be stopped in a short time with a small amount of nitrogen.

However, the above-described conventional method using the differential pressure control valve cannot ensure that the differential pressure always stays in a predetermined range when pressure varies rapidly or troubles occur in the valves or in the differential pressure meters or an air feed line, a power source or other components. Moreover, the differential pressure control between anode and vessel and between cathode and vessel are independent so that if some problems occur to a single line, there could be an increase in differential pressure between electrodes, causing the breakage of a fuel cell.

Due to the high operating temperature of Molten Carbonates Fuel Cells (hereafter called MCFC), high temperature control valves have to be used, what constitutes an high impact on the total costs of the plant.

Therefore, this conventional method has a problem in reliability and the components employed are very expensive.

### SUMMARY OF THE INVENTION

It is therefore an object of the present invention to provide a MCFC system which allows to avoid the technical disadvantages of the prior art and which is at the same time cost-effective.

This is obtained by means of a molten carbonate fuel cell system according to the present invention in which the fuel cell stack is enclosed within a containment vessel and in which a catalytic burner exhaust is used to control the system operating pressure. Moreover, a highly reliable, simple and low-cost differential pressure control method which is never affected by service interruption or troubles in control valves or in differential control meters or in other components is disclosed.

The molten carbonate fuel cell system according to the present invention comprises a containment vessel, a fuel cell stack enclosed within the containment vessel and a catalytic combustor next to the vessel in which a mixture of the anodic exhaust, the cathodic exhaust and the vessel exhaust flow and are combusted.

A pressure control valve is located on the combustor exhaust line and a relief valve is positioned on the vessel exhaust line.

This fuel cell system guarantees dynamic pressure balance between the vessel and fuel cell reactants and prevents leakage of the reactants from the fuel cell stack by guiding the anode, cathode and vessel exhaust gases to the inlet of a catalytic burner and by mixing them therein, so that the pressure of these gases are equal to each other.

In this way, it is also possible to avoid an excessive differential pressure between fuel cell and vessel and between the anode and the cathode. Moreover, by excluding differential control valves from the plant, the costs are substantially reduced.

In case of a control failure, this method allows to maintain the system at a constant pressure and temperature without the risk of high differential pressure between electrodes, what could cause breakage of the fuel cell stack.

### DETAILED DESCRIPTION OF THE PREFERRED EMBODIMENTS

The preferred embodiments of the present invention will be described with reference to FIG. 1.

A pressurised fuel feed line 1 is connected to the anode of the fuel cell stack. A pressurised oxidant feed line 2 is introduced into the cathode and inert gas (N₂) air or other mixtures like cathodic exhaust is fed to the containment vessel through line 3.

The system pressure is controlled by the valve V2 downstream of the catalytic burner, the pressure sensor and pressure controller.

Valve V1, located on the vessel exhaust line, maintains constant the required differential pressure between the vessel and the fuel cell reactants in order to prevent leakage of reactants to the vessel atmosphere.

In this case, the anode, the cathode and the vessel exits are all at the same pressure, which is balanced and equilibrated inside the catalytic burner that acts as reference point. Anode and cathode pressures are always equilibrated unless pressure drop occurs in the passage trough the stack.

In this way there are no significant differential pressure changes between anode-cathode and stack-vessel.

When that occurs, they are in a range of some mbar, even if there is a failure on the cathode or anode stream.

The system is closely equilibrated and allows to minimise the risks of differential pressure between electrodes and between the fuel cell stack and the vessel.

The vessel can be at room temperature or higher, the only technical characteristic which has to be modified resides in the valve V1, which can be “fail-open kind”, with low pressure drop, abounding or equipped with bypass in the case of his casual shutting.

Furthermore, the valve located downstream of the catalytic burner has an appropriate capacity to avoid the pressure control loss or can be properly redounded.

In comparison with the separate pressure control on the three streams (anode, cathode and vessel), this pressure control device implies that the power plant can be provided with a catalytic burner (CB) or other proper mixing device allowing anode and cathode gas safe mixing/burning where the exhausted gases are guided; setting the valve V1 (or a calibrated orifice) the vessel can be maintained at a slight overpressure on the stack allowing intrinsic safe operation without gas leakage from the stack to the containment vessel; the advantage of a minimum number of control valves; the advantage of an automatic pressure balance (an actual safety for the stack); the advantages of a passive control system without any component that could fail; in the case of control system failure, the advantage that the system temperature and pressure do not need to decrease to room conditions.

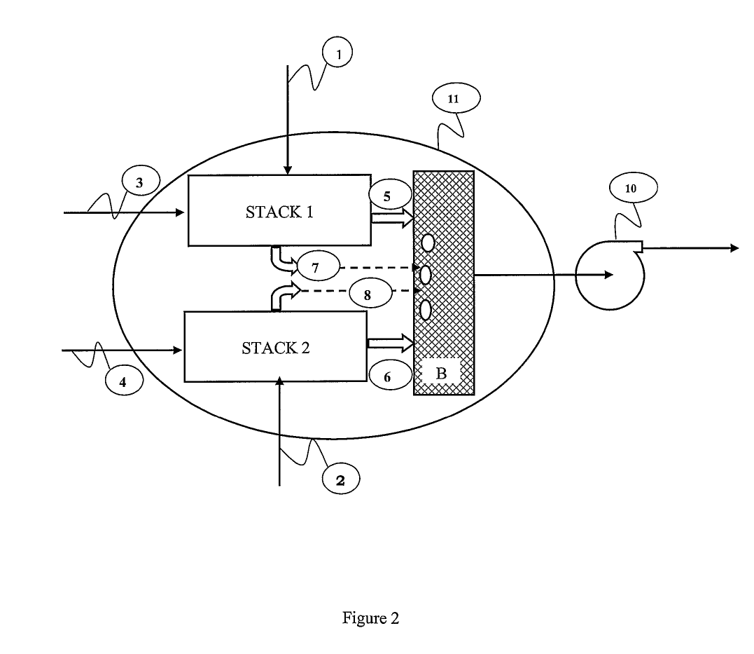

Another embodiment of the fuel stack system according to the present invention is shown in FIG. 2.

Here two stacks 1 and 2 are fed by the lines 1-2 at the cathode and by the lines 3-4 at the anode. In this embodiment as well the stacks as the burner (B) are contained inside the vessel 11.

The exhausted anodic gas is brought to the B by means of the conducts 5 and 6. The exhausted cathodic gas is introduced directly into the vessel (arrows 7 and 8) and forms the covering atmosphere. By means of the outlet 10 a slightly low pressure is formed in the B, so that the gas contained in the vessel is aspired inside the B through the indicated openings.

Since the atmosphere in the vessel is constituted by the cathodic gas containing oxygen, meets inside the B the exhausted anodic gas containing hydrogen and the fuel not reacted of the cell and the combustion occurs.

In this case too, the B constitutes the common element for the cathodic and the anodic flow and the atmosphere in the vessel, forming an equipotential point for the pressures of these three parts.

The main differences with the previous embodiment are the following ones:
one ore more stacks can be contained in the same vessel
one or more stack can be connected to the common point
the internal environment of the vessel is at high temperature (˜650° C.)
the internal atmosphere of the vessel is not inert but contains diluted air
the vessel is not fed independently but from the cathodic gas itself.
the B is placed inside the vessel

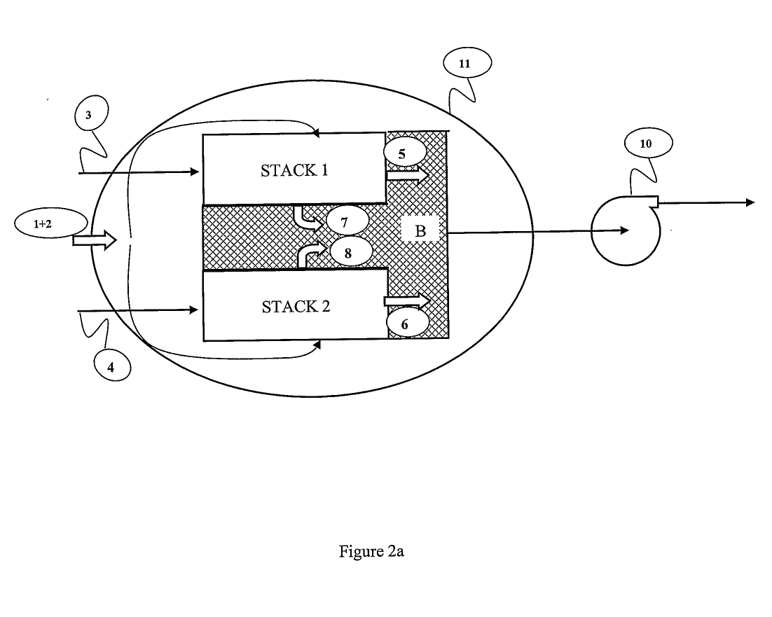

The overpressure condition of the vessel can be re-established by means of the scheme in FIG. 3, where the vessel is fed with the same mixture of the cathodic inlet. The cathodic and anodic outlets are both carried to the B by means of conducts. The vessel is always in conditions of overpressure over the stack(s).

1. Molten carbonate fuel cell power plant system comprising:
a containment vessel
one or more molten carbonate fuel cell stack(s), enclosed within said containment vessel
a burner for combusting a mixture of anodic exhaust, cathodic exhaust and vessel exhaust to produce a burner exhaust stream
means for maintaining the system pressurised
means for maintaining a differential pressure between the containment vessel and fuel and oxidant streams to prevent leakage of fuel and oxidant from fuel cell stack

2. Fuel cell power plant according to claim 1, wherein said burner is a catalytic burner.

3. Fuel cell power plant according to claim 1 or 2, wherein the differential pressure between the containment vessel and the fuel and oxidant streams is positive.

4. Fuel cell power plant according to one of the claims 1 to 3,
wherein the means for maintaining the system pressurised comprise means for sensing the system pressure and means for providing control signal indicative of said pressure.

5. Fuel stack power plant according to the claims 1 and 2,
wherein said burner (B) is placed inside said containment vessel (11).

6. Fuel cell power plant according to claim 5 wherein the differential pressure between the containment vessel and the fuel and oxidant streams is negative.

7. Fuel cell power plant according to claim 5 or 6 wherein the means for maintaining the system pressurised comprise means for sensing the system pressure and means for providing control signal indicative of said pressure.

8. Method for operating a molten carbonate fuel cell stack system according to the claims 1 to 7, comprising the steps of:
electrochemically reacting a pressurised fuel stream and a pressurised oxidant stream in the fuel stack(s) to produce electricity, anodic exhaust stream and cathodic exhaust stream;
combusting in the burner a mixture of anodic exhaust, cathodic exhaust and vessel exhaust to produce a combustion exhaust stream
maintaining under control the required differential pressure between the containment vessel and the fuel cell stack
maintaining minimal the anode-cathode differential pressure during the functioning

9. Method according to claim 8, further comprising the steps of
sensing the system pressure
providing a signal indicative of such sensed pressure, and
controlling the pressure of the combustor exhaust stream so that the system pressure is constantly at a desired value.

10. Method according to claim 8 or 9,
wherein said mixture of anodic exhaust, cathodic exhaust and vessel exhaust is combusted in said burner
